(19) United States
(12) Patent Application Publication
(10) Pub. No.: US 2026/0296366 A1
(43) Pub. Date: Oct. 1, 2026

(54) WIRELESS CAR ALARM SYSTEMS AND METHODS

(71) Applicant: KYCS GLOBAL INC., Schomberg (CA)

(72) Inventor: Dave DA SILVA, Alliston (CA)

(21) Appl. No.: 19/562,338

(22) Filed: Mar. 10, 2026

Related U.S. Application Data
(60) Provisional application No. 63/780,671, filed on Mar. 31, 2025.

(51) Int. Cl. B60R 25/10; B60R 25/104; B60R 25/31; B60R 25/32; B60R 25/40

(52) U.S. Cl. CPC B60R 25/1004; B60R 25/1018; B60R 25/104; B60R 25/31; B60R 25/32; B60R 25/403; B60R 2325/101

(57) ABSTRACT

There is provided a theft prevention system for a vehicle. The system may include one or more wireless beacons positioned at various locations on or within the vehicle. The beacons may include one or more sensors and a speaker. A controller may arm and/or disarm the beacons. The beacons may emit an alarm signal in response to detecting movement while in an armed state. The beacon system may be independent of the vehicle's OEM alarm system.

### CROSS-REFERENCE TO RELATED APPLICATIONS

This claims the benefit of, and priority to, U.S. Provisional Patent Application No. 63/780,671, filed on Mar. 31, 2025, the entire contents of which are incorporated herein by reference.

### FIELD

This relates generally to alarm systems, and in particular to alarm systems for vehicles.

### BACKGROUND

Theft of motor vehicles is persistent global issue. Although most motor vehicles are equipped with an alarm system, such systems are predictable and can often be easily circumvented and/or disabled by experienced thieves.

Accordingly, there is a need for alarm systems and methods which are less easily circumvented and deter thieves.

### SUMMARY

In accordance with an aspect of the present invention, there is provided a theft prevention system for a vehicle, the system comprising: one more wireless beacons configured to be positioned at one or more respective locations on or within said vehicle, each of said beacons comprising one or more sensors and a speaker; a controller in communication with said one or more beacons, said controller operable to cause said one or more beacons to enter at least one of an armed state and/or a disarmed state; wherein at least one of said beacons is configured to emit an alarm signal in response to detecting movement.

In accordance with another aspect, there is provided a method for monitoring a vehicle, the method comprising: providing one or more wireless beacons within said vehicle, each of said beacons comprising one or more sensors and a speaker; arming, by a controller in communication with said one or more beacons, said one or more beacons; emitting, by said beacon, an alarm signal in response to detecting movement via at least one of said sensors.

### DESCRIPTION OF THE FIGURES

In the figures, which illustrate example embodiments,

FIG. 1 is a block diagram of components of an example computing device;

FIG. 2 is a block diagram showing software applications at the mobile communication device of FIG. 1;

FIG. 3 is a schematic diagram of components of a vehicle computer system;

FIGS. 4A and 4B are top and side elevation views, respectively, of a vehicle incorporating an anti-theft system, in accordance with some embodiments; and

FIG. 5 is a block diagram depicting example components of the anti-theft system depicted in FIGS. 4A and 4B.

### DETAILED DESCRIPTION

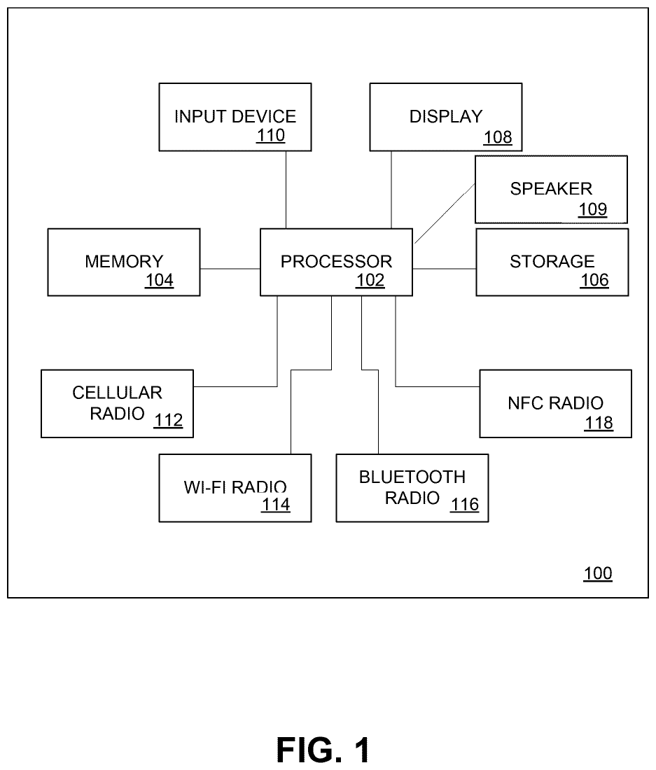

Various embodiments described herein may incorporate the use of computing devices. FIG. 1 depicts a block diagram of an example computing device 100. For example, computing device 100 may be a smartphone, a remote control system (such as those found in car key fobs, garage door opening systems, remote starters, and the like), a wireless alarm beacon 214 as described herein, or the like. For example, the interior of a motor vehicle may contain a plurality of wireless alarm beacons 214 which may be armed and/or disarmed by operation of a remote controller device, a mobile communication device (e.g., a smartphone), or the like.

Mobile device 100 may include a processor 102. Processor 102 may be an Intel™ x86 processor, ARM™ processor, or the like. Processor 102 is interconnected with a memory 104 and persistent storage 106. Processor 102 is further interconnected with one or more output devices such as display devices 108, audio speaker 109, and one or more input devices 110, such as a touch-sensitive panel, keyboard or the like.

Processor 102 may further be interconnected with a plurality of communications radios. For example, mobile communication device 100 may have at least one cellular radio 112 for voice or data communications on a wireless network. Processor 102 may also be interconnected with one or more of a Wi-Fi radio 114, a Bluetooth radio 116 and a near-field communication (NFC) radio 118.

Cellular radio 110 may be operable, for example, interface mobile communication device 100 to a 2G/3G/4G/LTE/5G GSM or CDMA cellular network. Wi-Fi radio 114 may be operable to wirelessly interface mobile communication device 100 to a local-area network, for example, using IEEE 802.11a/b/g/n/ac/ax standards. Bluetooth radio 116 may be operable to interface mobile communication device 100 with neighboring Bluetooth devices (such as beacons 214) according to a Bluetooth protocol. NFC radio 118 may be operable to behave in any of a plurality of standard NFC protocols. NFC radio 118 may be capable of operating in a plurality of different modes, including NFC card emulation modes, NFC reader/writer modes and NFC peer-to-peer modes. One or more of cellular radio 110, wi-fi radio 114, Bluetooth radio 116 and NFC radio 118 may be capable of receiving signals according to corresponding wireless communication protocols and reporting an associated signal strength.

In some embodiments, one or more components of mobile communication device 102 may be formed as portions of a single semiconductor die, referred to as a “system-on-chip”. Alternatively, components may be formed as separate semiconductor dies, in communication through one or more buses on a circuit board.

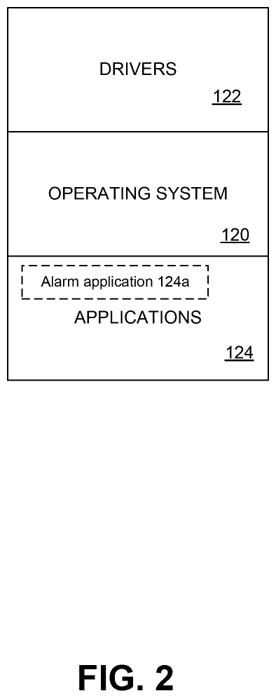

Mobile device 100 may operate under control of software stored on storage 106 and executed by processor 102. FIG. 2 depicts example software components.

Software components may include an operating system 120, such as Apple™ iOS™, Android™, Microsoft™ Windows™, Linux or the like. Operating system 120 may interface with hardware components of mobile communication device 100 by way of drivers 122. A plurality of applications 124 may run within operating software 120. Operating system 120 may provide applications 124 with access to low-level (e.g. hardware) functions of mobile communication device 100 by way of application programming interfaces (APIs).

By way of example, applications 124 may include a phone dialer, an email client, an internet browser, messaging applications, social media applications, media players, alarm configurations, and the like. Applications 124 may further include one or more settings applications for controlling functions of mobile communication device 100. The settings applications may, for example, toggle components such as cellular radio 112, Wi-Fi radio 114, Bluetooth radio 116 and NFC radio 118 ON or OFF. The settings applications may further enable or disable other applications from running, or enable or disable specific files or file types from being opened. The settings applications may further enable the output of sound and/or disable the output of sound.

The settings applications may be operable in response to user input, for example, touching a button or screen, detection of an object in motion or physical proximity, or to an event such as a received message, data transmission, signal or the like. Settings may therefore be altered in response to a transmission received on any of cellular radio 112, Wi-Fi radio 114, Bluetooth radio 116 or NFC radio 118.

In an embodiment, applications 124 may include an alarm application 124a. Alarm application 124a may be operable to receive signals from a radio such as NFC radio 118 Bluetooth, radio 116, Wi-Fi radio 114 or cellular radio 112. Alarm application 124a may also be operable to access and change settings of other applications 124 or of operating system 120. For example, as described in further detail hereinafter, alarm application 124a may be operable to receive a signal indicating that an armed alarm mode should be invoked. In response to the received signal, alarm application 124a may enable and/or disable certain functions of mobile communication device 100 and/or of beacons 214.

In some embodiments, when armed alarm mode is active, alarm application 124a may, for example, enable one or more sensors of beacons 214. For example, alarm application 124a may cause beacons 214 to enter a state in which one or more sensors (e.g. vibration sensors, proximity sensors, infrared sensors placed within a vehicle) are operable to detect unwanted activity within the vehicle. As described further below, beacons 214, when in the armed alarm mode, may be configured to output loud sounds when motion and/or otherwise unwanted activity is detected within the vehicle. In some embodiments, the emitted sounds may be on the order of 120 decibels (dB). Alternatively or additionally, alarm application 124a may disable the operation of beacon sensors and/or speakers (e.g., when the system is in an unarmed state).

In some embodiments, alarm application 124a or functions thereof may be incorporated into operating system 120 of mobile device 100. In other embodiments, alarm application 124a may be given elevated permissions on installation or at runtime, such as read/write/execute access to a root directory of persistent storage 106.

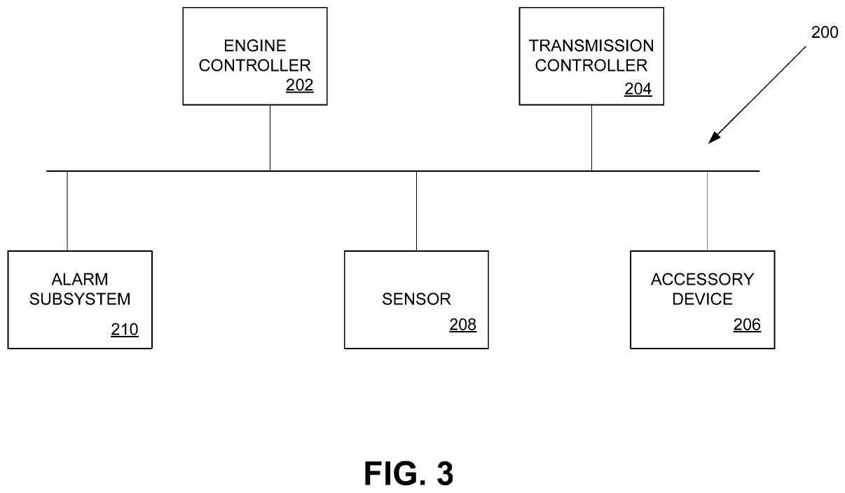

FIG. 3 depicts a simplified schematic view of a vehicle computer system 200. As depicted, vehicle computer system 200 may include an engine controller 202, a transmission controller 204, one or more accessory devices 206, one or more sensors 208 and an alarm subsystem 210. Components of vehicle computer system 200 may be in communication over a network such as a controller area network (CAN) bus.

Engine controller 202 may be operable to control, measure and report engine conditions to other components of vehicle computer 200. For example, engine controller 202 may notify other components of engine RPM, throttle position, load, and the like.

Transmission controller 204 may be operable to control, measure and report transmission conditions to other components of vehicle computer 200. For example, transmission controller 204 may notify other components of vehicle computer 200 of gear selected, transmission speed, temperature and load, and the like.

Accessory devices 206 may be, for example, radios, navigation systems, climate control systems and the like.

Sensors 208 may be vehicle condition sensors such as air or fuel flow meters, speed sensors, tire pressure sensors, temperature sensors, door position sensors, and the like.

As described in further detail below, alarm subsystem 210 may be configured to receive signals from one or more of engine controller 202, transmission controller 204, accessories 206 and sensors 208 and, based on the received signals, send a signal to activate a car alarm, which may begin emitting loud audible noises to attract attention. For example, in a legacy car alarm subsystem 210 which is integrated into a vehicle, when the alarm system is armed, there are a number of actions which may trigger activation of alarm sirens, flashing lights, honking horns, and the like.

For example, if the vehicle is locked and the alarm system is armed, if a door position sensor detects that a door has been opened, this may indicate that a thief has gained unauthorized entry into the vehicle. Likewise, if the alarm system is armed, if the engine controller 202 detects that the engine of the car has been started, this may be indicative that a thief has gained entry into the car and has started the engine (e.g., by hot-wiring, by cloning the signal from a wireless key fob, or the like).

Unfortunately, experienced thieves often find ways to circumvent the OEM alarm systems which are commonly integrated into a vehicle at the time of manufacture. For example, if the alarm is sounding because a door has been opened during the locked/armed state, the thief may succeed in disabling the alarm by once again closing the door once they have entered the vehicle. In other examples, a door alarm may be circumvented by entering the vehicle via other means (e.g., through a vehicle window). Likewise, modern vehicles feature On-Board Diagnostic (e.g., OBD2) ports, which may be commandeered by thieves to reprogram the native car alarm subsystem 210 to disable an alarm.

Given the inherent weakness in conventional anti-theft systems present in modern automobiles, it would be beneficial to supplement existing alarm systems with systems which are more effective at detecting unauthorized attempts at entry, and are more difficult for thieves and malfeasants to disable. If a thief is unable to disable a sounding alarm within a certain amount of time, the thief may be more likely to abandon the attempted theft. As such, some embodiments may be effective in preventing the theft of automobiles.

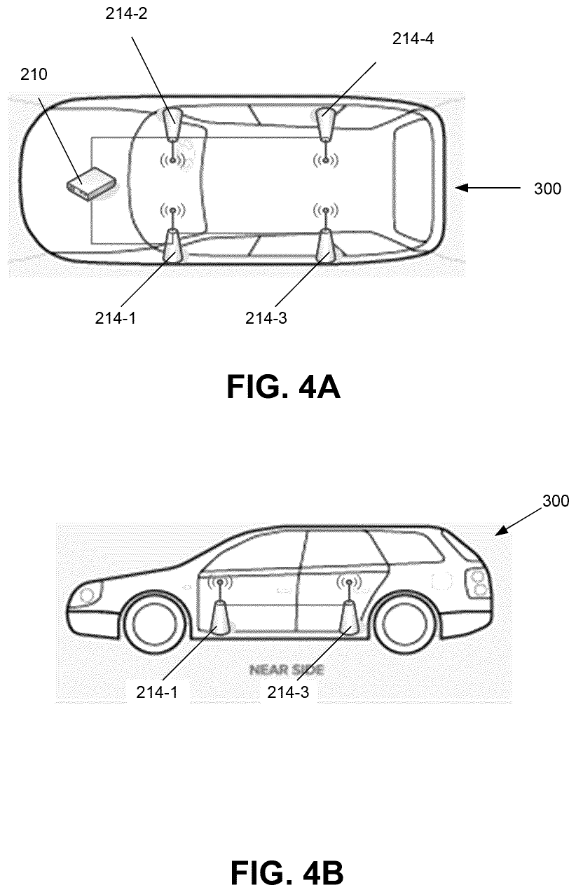

FIGS. 4A and 4B are top and side elevation views, respectively, of a vehicle incorporating an anti-theft system 500, in accordance with some embodiments. As depicted, vehicle 300 may include a plurality of transceivers 214, also referred to herein as beacons 214. As depicted, anti-theft system 500 includes four transceivers 214-1, 214-2, 214-3, 214-4 which are distributed at various locations throughout vehicle 300. Although FIGS. 4A and 4B depict 4 beacons, it is contemplated that other embodiments may include more than 4 beacons, or less than 4 beacons.

In some embodiments, each of beacons/transceivers 214 may be a battery-powered device. In some embodiments, each beacon 214 may operate independently from car alarm subsystem 210. That is, in some embodiments, beacons 214 may require a disabling signal from a device which is independent from car alarm subsystem 210. In this manner, an experienced car thief will not be successful in disabling beacons 214 even if they are successful in disabling the native car alarm system equipped to a vehicle 300 at the factory. This may prevent an additional obstacle and deterrent for car thieves, as a stolen vehicle 300 is significantly more conspicuous when loud noises are being emitted from sirens within the vehicle.

In some embodiments, each beacon 214 may include one or more of a motion-activated sensor, a sound-activated sensor, and/or a proximity-activated sensor, each of which may be configured to trigger an alarm siren of the respective beacon 214. The placement of each beacon 214 within vehicle 300 may be determined based on the unique characteristics of the vehicle in question, as described further below.

In some embodiments, each of beacons/transceivers 214 may be operable to send and receive signals according to a wireless communication protocol, such as a radio frequency, cellular, wi-fi, Bluetooth or NFC protocol. For example, in embodiments which include two or more beacons 214, a first beacon 214-1 which is triggered to sound an alarm may be configured to communicate with other beacons 214-2, 214-3, 214-4 to trigger the sounding of alarms on the other beacons within vehicle 300.

In other embodiments, transceivers 214 may be Wi-Fi, Bluetooth, cellular, or other appropriate wireless transceivers and may send and receive signals according to an appropriate wireless protocol for communication with mobile devices using a corresponding mobile device radio.

As depicted in FIGS. 4A-4B, beacons 214-1, 214-2, 214-3, 214-4 (individually and collectively, beacons/transceivers 214) are located at differing locations around the passenger cabin. As depicted, transceiver 214-1 is located in the front driver's side of the cabin; transceiver 214-2 is located in the front passenger side; transceiver 214-3 is located in the rear driver's side and transceiver 214-4 is located in the rear passenger side. In some embodiments, transceivers 214 may be mounted inside respective structural pillars of the vehicle cabin. Transceivers 214 may be mounted, for example, between panels of vehicle 300 and upholstery (e.g. the headliner) of vehicle 300. In some embodiments, transceivers 214 may be mounted so that metallic members of vehicle 300 do not interfere with sending and receiving signals.

Optionally, in some embodiments, transceivers 214 may be configured to communicatively couple with alarm subsystem 210 (as depicted in FIG. 4A). For example, in vehicles which support Bluetooth communication, some embodiments may allow for beacons 214 to register with and communicate with a vehicle's OEM car alarm subsystem 210 for more comprehensive integration with the vehicle's alarm system. For example, in addition to emitting a loud siren from its speaker, beacon 214 might also be configured to communicate an alarm condition to alarm subsystem 210, thereby triggering the vehicle's alarm siren (e.g. a honking horn, a siren, and/or flashing lights). In some embodiments, beacons 214 which are coupled with control systems of vehicles which maintain an internet connection may be accessed remotely (i.e., when the user is not within range of vehicle 300 to use a remote control), thus allowing beacons to begin emitting sirens in the event that 300 has been stolen or moved unexpectedly. In some embodiments, transceivers 214 may be configured to couple with other components in vehicle 300, such as engine controller 202, transmission controller 204, accessory device 206, and/or sensors 208. For example, transceivers 214 may be configured to communicatively couple with vehicle 300 to allow for the control and/or disabling of vehicle 300's fuel pump and/or other operating functions of vehicle 300. In this manner, transceivers 214 may be configured to disable or prevent activation of other subsystems (e.g., a vehicle ignition system) of vehicle 300 in order to reduce the likelihood of a malfeasant being able to drive vehicle 300 in the event that an alarm state has been triggered.

In other embodiments, beacons 214 may operate independently of car alarm subsystem 210, so as to reduce the possibility of a security vulnerability in the OEM alarm subsystem 210 being used to disable beacons 214. In some embodiments, beacons 214 may be remotely armed and disarmed using a remote control possessed by a user. In some embodiments, the remote control may communicate with beacons 214 using radio frequencies to arm and disarm the beacons 214. In some embodiments, the remote control may communicate with beacons 214 using one or more of Bluetooth, NFC, Wi-Fi, cellular packet data (e.g., 3G/4G/LTE/5G, and the like), to arm and disarm beacons 214.

In some embodiments, the remote-control device may communicate with beacons 214 using frequencies which are higher than 1 GHz. At present, certain products are commercially available (so-called “flippers”) which are capable of intercepting and duplicating signals which are under 1 GHz. Flippers are frequently used to intercept and duplicate various signals used for the operation of vehicles (e.g., the signals from a car key to lock and unlock the vehicle, the signal to open or ‘pop’ the trunk of the vehicle, the signals to arm and disarm the vehicle's OEM alarm system, and the short-range signal which is broadcast by a car key to enable operation of so-called “push-button” ignition systems). As such, the use of frequency ranges higher than 1 GHz may be useful in hindering thieves from duplicating control signals for arming and disarming beacons 214. In some embodiments, the remote-control device may communicate with beacons 214 using a “frequency hopping” configuration which switches between a plurality of predetermined transmission frequencies in a pre-determined order. In this manner, devices such as frequency jammers and signal duplication devices may be less effective in obtaining and/or duplicating control signals transmitted between beacons 214 and remote-control devices.

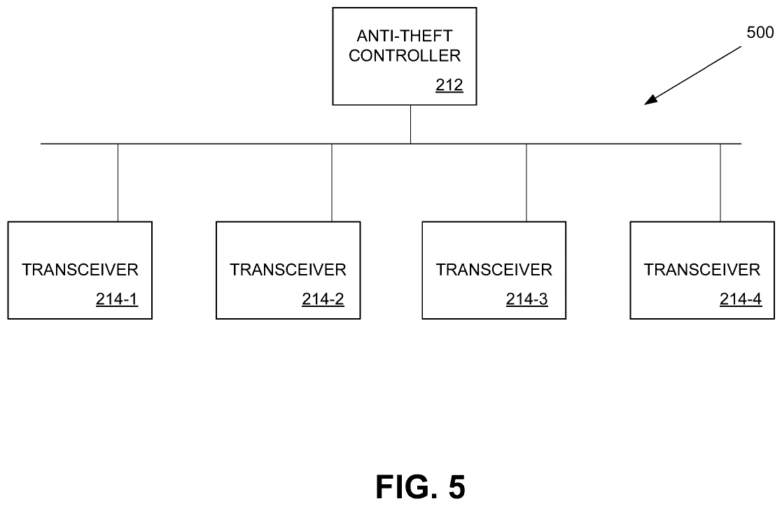

FIG. 5 is a block diagram depicting example components of an anti-theft system 500, in accordance with some embodiments. As depicted, transceivers/beacons 214 are communicatively coupled to anti-theft controller 212. In some embodiments, anti-theft controller is located in the remote control device which a user may use to arm and disarm beacons 214. It should be appreciated that although FIG. 5 depicts connections between beacons 214 and anti-theft controller 212, such connections may be wired and/or wireless.

Returning to FIGS. 4A and 4B, beacons 214 may be distributed in various locations throughout vehicle 300. In some embodiments, the location of at least one beacon may be selected so as to increase the likelihood of detecting break-in attempts relative to the vehicle's OEM system.

For example, it is commonplace for a car thief to break the rear window of a vehicle (so as to avoid broken glass collecting in the driver's seat, and to avoid triggering any alarm system which would be triggered by opening any of the doors of vehicle 300) to gain entry to the interior of a vehicle, and then tap into the vehicle's ODB2 computer to reprogram a key fob, which can be used to disable the vehicle's OEM alarm system.

In some embodiments, a beacon 214 my include an infrared (IR) sensor configured to detect movement. IR sensors may be particularly useful for use with motor vehicles, as IR radiation does not transmit through glass, and as such, it is unlikely that an IR motion sensor of beacon 214 positioned within the cabin of vehicle 214 would be triggered by motion occurring exterior to vehicle 300.

In some embodiments, beacons 214 may include a vibration motion sensor. A vibration motion sensor may be useful for detecting events such as a) the engine of the vehicle being turned on (resulting in a baseline level of vibration in the case of internal combustion engines), as well as the vibration generated when vehicle 300 is being any of lifted, towed, or even when the nuts on wheels are being pried off.

In some embodiments, beacons 214 may include a motion sensor such as an accelerometer and/or gyroscope. Such sensors may be useful in detecting when vehicle 300 is being lifted or towed, or otherwise being moved in a manner which is consistent with unauthorized access or movement.

In some embodiments, beacons 214 may include an audio output speaker. In some embodiments, the speaker may be configured to emit audible sound at volumes of 120 decibels or more. For example, when beacon 214 is in an armed state, the output of an unexpected sensor signal (e.g., the detection of motion, vibration, sound, or the like, when the vehicle is expected to be stationary and turned off) may cause beacon 214 to activate its speaker and begin emitting a siren.

In some embodiments, a beacon 214 may be affixed to the windshield of vehicle 300, and may include an infrared (IR) sensor configured to sense movement within the cabin of vehicle 300. Since IR radiation does not transmit through glass (i.e., IR radiation is reflected by a windshield), it is highly unlikely that movement on the exterior of vehicle 300 would be detected, thereby avoiding the potential for false positive alarm triggers. Thus, if a thief is able to gain entry to the cabin of vehicle 300, the beacon 214 will detect motion in the interior of the car and begin sounding its siren. In some embodiments, beacon 214 may transmit a signal which activates the sirens on any other beacons 214 which are present within vehicle 300.

In some embodiments, beacons 214 may placed on or in any of a door panel, the trunk, under the hood of vehicle 300 (e.g. affixed using, for example, an epoxy adhesive), and the like. It should be appreciated that these placement locations are merely examples and that beacons 214 may be placed in any location in vehicle 300 which is desired by the owner.

In some embodiments, beacons 214 may be battery operated. This may advantageous in that being powered independently from the electrical systems of vehicle 300 may provide a more robust security system (in that beacons 214 could not be disabled by disconnecting the battery terminals of vehicle 300). In some embodiments, batteries may be removable (so as to replace dead batteries with new batteries). In some embodiments, batteries may be permanent.

In some embodiments, beacons 214 may be configured to, when armed, emit a warning sound when triggered, prior to emitting a siren. For example, beacon 214 may be configured to emit a ‘chirp’ for a predetermined period of time. In some embodiments, the predetermined warning period of time may be 2 seconds. In some embodiments, the predetermined warning period of time may be selected by the user in accordance with the particular context and needs of the user. A warning chirp may be useful in scenarios in which system 500 is armed and inadvertently triggered. For example, if a user forgets to disarm system 500 when entering their vehicle 300, the emission of a warning chirp for a short period of time may provide the user with sufficient time to disarm system 500 (e.g., by pressing a button on the remote controller).

In still other embodiments, the remote controller may include a button for providing ‘find my vehicle’ functionality. When pressed, the ‘find my vehicle’ function may cause one or more beacons to emit a chirping sound so as to facilitate a user locating their vehicle (e.g., when in a busy parking lot or parkade). In still other embodiments, the remote controller may include functionality for emitting a chirping sound, so as to confirm beacons 214 are functional. In some embodiments, beacons 214 may be configured to emit an audible chirp in response to a command to enter an armed state.

In some embodiments, remote controller may be a computing device 100, such as a smartphone. In some embodiments, smartphone 100 may have an application installed thereon (such as alarm application 124a) which is configured to communicate with beacons 214 (e.g., via Bluetooth, NFC, Wi-Fi, and other radio frequencies). In some embodiments, beacon 214 may be operable to interface with GPS and/or telematics tracking systems, as well as other communications systems of vehicle 300. In this manner, beacons 214 may be configured to transmit location information to external computing devices, and to receive commands remotely via one or more integrated systems of vehicle 300. For example, beacons 214 may be activated remotely via a command to another integrated system of vehicle 300, which may then relay the command to beacons 214.

The embodiments of the devices, systems and methods described herein may be implemented in a combination of both hardware and software. These embodiments may be implemented on programmable computers, each computer including at least one processor, a data storage system (including volatile memory or non-volatile memory or other data storage elements or a combination thereof), and at least one communication interface.

Program code is applied to input data to perform the functions described herein and to generate output information. The output information is applied to one or more output devices. In some embodiments, the communication interface may be a network communication interface. In embodiments in which elements may be combined, the communication interface may be a software communication interface, such as those for inter-process communication. In still other embodiments, there may be a combination of communication interfaces implemented as hardware, software, and combination thereof.

The following discussion provides many example embodiments. Although each embodiment represents a single combination of inventive elements, other examples may include all possible combinations of the disclosed elements. Thus if one embodiment comprises elements A, B, and C, and a second embodiment comprises elements B and D, other remaining combinations of A, B, C, or D, may also be used.

The term “connected” or “coupled to” may include both direct coupling (in which two elements that are coupled to each other contact each other) and indirect coupling (in which at least one additional element is located between the two elements).

The technical solution of embodiments may be at least partly in the form of a software product. The software product may be stored in a non-volatile or non-transitory storage medium, which can be a compact disk read-only memory (CD-ROM), a USB flash disk, or a removable hard disk. The software product includes a number of instructions that enable a computer device (personal computer, server, or network device) to execute the methods provided by the embodiments.

Although the embodiments have been described in detail, it should be understood that various changes, substitutions and alterations can be made herein without departing from the scope as defined by the appended claims.

What is claimed is:

1. A theft prevention system for a vehicle, the system comprising:
one more wireless beacons configured to be positioned at one or more respective locations on or within said vehicle, each of said beacons comprising one or more sensors and a speaker;
a controller in communication with said one or more beacons, said controller operable to cause said one or more beacons to enter at least one of an armed state and/or a disarmed state;
wherein at least one of said beacons is configured to emit an alarm signal in response to detecting movement.

2. The system of claim 1, wherein said one or more beacons are powered independently from a power source of said vehicle.

3. The system of claim 1, wherein said one or more beacons are independent from an Original Equipment Manufacturer (OEM) alarm system of said vehicle.

4. The system of claim 1, wherein said controller communicates with said one or more beacons via a radio frequency signal.

5. The system of claim 4, wherein said radio frequency signal has a frequency higher than 1 GHz.

6. The system of claim 1, wherein said controller communicates with said one or more beacons via a Bluetooth signal.

7. The system of claim 1, wherein said one or more sensors comprise at least one of an infrared sensor, a proximity sensor, a vibration sensor, an accelerometer, and/or a gyroscope.

8. The system of claim 1, wherein said detected movement comprises movement within a cabin of said vehicle.

9. The system of claim 1, wherein said detected movement comprises movement of said vehicle.

10. The system of claim 1, wherein said detected movement comprises vibrations within said vehicle.

11. The system of claim 1, wherein said locations include a windshield of said vehicle, a cabin of said vehicle, a trunk of said vehicle, and a hood of said vehicle.

12. The system of claim 1, wherein said one or more beacons are configured to interface with one or more vehicle computing systems.

13. The system of claim 1, wherein said alarm signal is an audible noise.

14. The system of claim 13, wherein said audible noise has a volume of at least 120 decibels.

15. The system of claim 1, wherein said alarm signal comprises an audible chirp for a predetermined period of time.

16. The system of claim 15, wherein said predetermined period of time is two seconds.

17. The system of claim 4, wherein communicating via said radio frequency signal comprises frequency hopping between a plurality of predetermined frequencies.

18. A method for monitoring a vehicle, the method comprising:
providing one or more wireless beacons within said vehicle, each of said beacons comprising one or more sensors and a speaker;
arming, by a controller in communication with said one or more beacons, said one or more beacons;
emitting, by said beacon, an alarm signal in response to detecting movement via at least one of said sensors.
